(19) United States
(12) Patent Application Publication
(10) Pub. No.: US 2021/0028450 A1
(43) Pub. Date: Jan. 28, 2021

(54) ANODE ACTIVE MATERIAL, METHOD FOR PRODUCING ANODE ACTIVE MATERIAL, AND BATTERY

(71) Applicant: TOYOTA JIDOSHA KABUSHIKI KAISHA, Toyota-shi (JP)

(72) Inventors: Takayuki UCHIYAMA, Toyota-shi (JP); Satoshi WAKASUGI, Toyota-shi (JP); Shizuka MASUOKA, Toyota-shi (JP)

(21) Appl. No.: 16/928,074

(22) Filed: Jul. 14, 2020

(30) Foreign Application Priority Data
Jul. 26, 2019 (JP) 2019-138062
Mar. 26, 2020 (JP) 2020-056422

(51) Int. Cl. H01M 4/38; H01M 10/0525

(52) U.S. Cl. CPC H01M 4/386; H01M 2004/027; H01M 10/0525

(57) ABSTRACT

A main object of the present disclosure is to provide an anode active material of which expansion along with charge is small. The present disclosure achieves the object by providing an anode active material to be used for a battery, wherein the anode active material is a particle in unwoven shape that contains Si fiber, an average particle size D₅₀ of the anode active material is 0.2 μm or more and 3.6 μm or less, and the anode active material is amorphous.

### TECHNICAL FIELD

The present disclosure relates to an anode active material, a method for producing the anode active material, and a battery.

### BACKGROUND ART

In recent years, development of batteries has been actively conducted. For example, in the automobile industry, development of batteries to be used for electronic automobiles or hybrid automobiles and development of active materials to be used for the batteries have been advanced.

For example, Si-based active materials are known as one of anode active materials to be used for an anode layer of an all solid state battery. Patent Literature 1 discloses an all solid state battery in which a composite particle of Si and carbon is used as an anode active material. Patent Literature 2 and Patent Literature 3 disclose that a porous silicon is used as an anode active material.

### CITATION LIST

### Patent Literatures

Patent Literature 1: Japanese Patent Application Laid-Open (JP-A) No. 2017-054720

Patent Literature 2: JP-A No. 2013-008487

Patent Literature 3: JP-A No. 2013-203626

### SUMMARY OF DISCLOSURE

### Technical Problem

It is required for the anode active material that its expansion along with charge is small. The present disclosure has been made in view of the above circumstances and a main object thereof is to provide an anode active material of which expansion along with charge is small.

### Solution to Problem

In order to achieve the object, the present disclosure provides an anode active material to be used for a battery, wherein the anode active material is a particle in unwoven fabric shape that contains Si fiber, an average particle size D₅₀ of the anode active material is 0.2 μm or more and 3.6 μm or less, and the anode active material is amorphous.

According to the present disclosure, the anode active material is a particle in unwoven fabric shape that contains Si fiber, and thus expansion of the anode active material along with charge may be small.

In the disclosure, a peak “a” derived from Si positioned at 2θ=28.4°±0.5° in an XRD measurement using a CuKα ray may not be observed.

In the disclosure, a peak “a” derived from Si positioned at 2θ=28.4°±0.5° in an XRD measurement using a CuKα ray is observed, a peak “b” positioned at 2θ=24.0°−32.0° of which half value width is 3° or more is observed, and when Ia designates an intensity of the peak “a”, and Ib designates an intensity of the peak “b”, an XRD intensity ratio Ia/Ib may be 3.80 or less.

In the disclosure, a peak “c” derived from SiO₂ positioned at 2θ=20.8°±0.5° in an XRD measurement using a CuKα ray may not be observed.

In the disclosure, a peak “d” derived from lithium silicate positioned at 2θ=20°−30° may not be observed.

In the disclosure, an average diameter of the Si fiber may be 8 nm or more and 70 nm or less.

In the disclosure, an aspect ratio which is a ratio of average length/average diameter may be 1 or more and 50 or less.

The present disclosure also provides a method for producing an anode active material, the method comprising: a dispersing step of adding a dispersion medium to a LiSi precursor containing a Si element and a Li element to obtain a LiSi precursor dispersion solution; and a Li extracting step of extracting the Li element from the LiSi precursor by adding a Li extracting solvent to the LiSi precursor dispersion solution to obtain a particle in unwoven fabric shape that contains Si fiber, wherein a relative dielectric constant of the dispersion medium is 3.08 or less.

According to the present disclosure, the Li extracting step is conducted after the dispersing step, and thus the anode active material which is a particle in unwoven fabric shape that contains Si fiber can be produced.

In the disclosure, the dispersion medium may be at least one kind of n-butyl ether, 1,3,5-trimethyl benzene, and n-heptane.

In the disclosure, the Li extracting solvent may be at least one kind of ethanol, 1-propanol, 1-butanol, 1-hexanol, and acetic acid.

In the disclosure, the method may further comprise a washing step of washing the particle in unwoven fabric shape by an acid after the Li extracting step.

The present disclosure also provides a battery including a cathode active material layer, an anode active material layer, an electrolyte layer formed between the cathode active material layer and the anode active material layer, wherein the anode active material is the above described anode active material.

According to the present disclosure, the anode active material layer contains the above described anode active material, and thus the restraining pressure of the battery can be reduced.

### Advantageous Effects of Disclosure

One of the effects of the anode active material in the present disclosure is that its expansion along with charge is small.

### BRIEF DESCRIPTION OF DRAWINGS

FIG. 1 is a flow chart illustrating an example of the method for producing the anode active material in the present disclosure.

FIG. 2 is a schematic cross-sectional view illustrating an example of the battery in the present disclosure.

FIGS. 3A and 3B are the results of XRD measurement of the anode active material in Example 1.

FIG. 4 is a TEM image of the active materials respectively in Examples 1, 2, and Comparative Example 1.

FIG. 5 is a SEM image of the anode active material in Comparative Example 1.

FIG. 6 is the result of XRD measurement of the anode active materials in Examples 8 to 10.

### DESCRIPTION OF EMBODIMENTS

The anode active material, the method for producing the anode active material, and the battery in the present disclosure will be hereinafter described in details.

A. Anode Active Material

The anode active material in the present disclosure is an anode active material to be used for a battery, the anode active material is a particle in unwoven fabric shape that contains Si fiber, an average particle size D₅₀ of the anode active material is 0.2 μm or more and 3.6 μm or less, and the anode active material is amorphous.

According to the present disclosure, the anode active material is a particle in unwoven fabric shape that contains Si fiber, and thus expansion of the anode active material along with charge may be small. For example, as in Patent Literatures 1-3, it has been known that a Si particle having high capacity is used as an anode active material. However, when the Si particle is used as the anode active material, expansion of the anode active material along with charge would be large. Whereas, Patent Literature 1 has intended to inhibit the expansion by adjusting the particle size of the anode active material and allowing the anode (anode active material layer) to have a specified void. Also, Patent Literatures 2 and 3 have intended to inhibit the expansion by allowing the anode active material to be porous. However, there is a room for further improvement in reducing the expansion. Then, the inventors of the present disclosure have thoroughly conducted researches and found out that the anode active material in unwoven fabric shape in which Si fibers are three-dimensionally entangled was obtained with a specified method. The porous anode active material particle described in Patent Literatures 2 and 3 are considered to have a shape shown in the later described microscopic image of Comparative Example 1, and the shape of the anode active material in the present disclosure has not been conventionally known. Moreover, the inventors have found out that the expansion of the anode active material in the afore-mentioned shape during charge was further reduced.

Also, the anode active material in the present disclosure is amorphous. Amorphous, that is, a low crystalline silicon is considered to have longer Si—Si bond distance compared to that in a crystalline silicon; thus, it is considered that the expansion during intercalation of ions (during charge) would be further inhibited if the anode active material is amorphous.

Further, the anode active material in the present disclosure has a specified average particle size D₅₀. When anode active materials having a large average particle size are used for an anode active material layer, it is considered that the anode active material layer would be locally expanded largely because ions are intercalated into the anode active materials having a large particle size in priority basis. In contrast, with the average particle size of the present disclosure, it is considered that ions are intercalated into the entire anode active materials uniformly and the anode active material layer would be expanded uniformly. As a result, it is considered that the expansion of the anode active material layer as a whole may be inhibited.

The anode active material in the present disclosure will be hereinafter described in greater details.

The anode active material in the present disclosure is a particle in unwoven fabric shape that contains Si fiber. Incidentally, in the present disclosure, the unwoven fabric shape refers to a net shape in which Si fibers are three-dimensionally entangled.

The Si fiber in the present disclosure may have a specified average diameter. The average diameter is, for example, 8 nm or more, may be 10 nm or more, may be 15 nm or more, and may be 20 nm or more. Meanwhile, the average diameter is, for example, 70 nm or less, may be 60 nm or less, may be 50 nm or less, may be 40 nm or less, and may be 30 nm or less. Also, the Si fiber in the present disclosure may have a specified average length. The average length is, for example, 50 nm or more and 400 nm or less. The length of the Si fiber in the present disclosure here is defined as a length from a connection point (a point where a plurality of Si is connected) of one side to a connection point (a point where a plurality of Si is connected) of the other side. The average length and the average diameter of the Si fiber may be obtained in ways such as observation by a scanning electron microscope (SEM). The number of samples is preferably much; for example, it is 100 or more.

Also, the Si fiber in the present disclosure may have a specified aspect ratio which is a ratio of average length/average diameter. The aspect ratio which is a ratio of average length/average diameter is, for example, 1 or more, may be 5 or more, may be 15 or more, and may be 20 or more. Meanwhile, the aspect ratio which is a ratio of average length/average diameter is, for example, 50 or less, may be 40 or less, and may be 30 or less.

The Si fiber in the present disclosure may be a simple substance of Si, and may be an alloy that contains Si elements as its main component. The proportion of the Si elements in the alloy is, for example, 50 at % or more, may be 70 at % or more, and may be 90 at % or more. Examples of metal elements in the alloy other than the Si element may include a Li element.

The anode active material in the present disclosure has a specified average particle size D₅₀. The average particle size D₅₀ is 0.2 μm or more, and may be, for example, 0.5 μm or more, may be 1.0 μm or more, and may be 1.5 μm or more. Meanwhile, the average particle size D50 is 3.6 μm or less, and may be, for example, 3.0 μm or less, may be 2.5 μm or less, and may be 2.0 μm or less. When the anode active material having the average particle size D₅₀ in the above described range is used for the anode active material layer, it is considered that the expansion of the anode active material layer as a whole may be inhibited since ions are intercalated into the entire anode active materials uniformly to allow the anode active material layer to expand uniformly. The average particle size Dso may be obtained in ways such as observation by a scanning electron microscope (SEM). The number of samples is preferably much; for example, it is 100 or more. The method for adjusting the average particle size D₅₀ will be described in “B. Method for producing anode active material” later.

Also, the anode active material in the present disclosure is amorphous. The amorphous in the present disclosure here refers to a case where a halo peak (a broad peak in halo pattern) is confirmed in an XRD measurement using a CuKα ray. The halo peak preferably has a peak position at 2θ=24.0°−32.0° in the XRD measurement using a CuKα ray. In the same manner, the halo peak preferably has a peak position at 2θ=40.0°−60.0°. Also, the half value width of the halo peak is, for example, 3° or more, may be 5° or more, and may be 10° or more. Incidentally, in the present disclosure, the halo peak having a peak position at 2θ=24.0°−32.0° in the XRD measurement using a CuKα ray and the half value width of 3° or more (later described peak “b”) is preferably observed.

Also, in the anode active material in the present disclosure, a peak “a” derived from Si positioned at 2θ=28.4°±0.5° in an XRD measurement using a CuKα ray may not be observed or may be observed, but it means that the former has higher amorphous nature of the anode active material than that of the latter. The peak “a” is a peak derived from a Si crystal phase (Si crystal phase in a diamond shape). Also “the peak “a” is not observed” means that the intensity of the peak “a” is small to the extent that it is difficult to be distinguished from surrounding noise. This definition also applies to the peaks other than the peak “a”.

The peak position of the peak “a” may be 2θ=28.4°±0.4°, and may be 2θ=28.4°±0.2°. Also, the half value width of the peak “a” is usually smaller than the half value width of the peak “b”; for example, it is 3° or less, may be 1° or less, and may be 0.5° or less.

Also, in the anode active material in the present disclosure, a peak “b” positioned at 2θ=24.0°−32.0° of which half value width is 3° or more is usually observed in an XRD measurement using a CuKα ray. The peak “b” is one of halo peaks described above, which is a peak different from the peak “a”. The half value width of the peak “b” may be, for example, 4° or more, may be 5° or more, and may be 10° or more. Peak intensity Ib of the peak “b” may be calculated by fitting an obtained diffraction pattern.

When the peak “a” is observed and Ia designates the intensity of the peak “a” and Ib designates the intensity of the peak “b”, an XRD intensity ratio Ia/Ib may be in a specified range. The XRD intensity ratio Ia/Ib is, for example, 3.80 or less, may be 3.50 or less, may be 3.00 or less, and may be 2.50 or less. Meanwhile, the XRD intensity ratio Ia/Ib is, for example, 0.95 or more, may be 0.99 or more, may be 1.50 or more, and may be 2.00 or more. A method for adjusting the XRD intensity ratio will be described in “B. Method for producing anode active material” later. Incidentally, the “intensity of the peak” refers to a height from an X axis (2θ) in a diffraction chart.

Also, in the anode active material in the present disclosure, a peak “c” derived from SiO₂ positioned at 2θ=20.8°±0.5° in an XRD measurement using a CuKα ray may not be observed or may be observed, but the former is preferable. The reason therefor is to allow the anode active material to have less impurities. The peak position of the peak “c” may be 2θ=20.8°±0.4°, and may be 2θ=20.8°±0.2°. Also, the half value width of the peak “c” is usually smaller than the half value width of the peak “b”; for example, the peak “c” is 3° or less, may be 1° or less, and may be 0.5° or less.

When the peak “a” and the peak “c” are observed, Ia designates the intensity of the peak “a” and Ic designates the intensity of the peak “c”, an XRD intensity ratio Ic/Ia is preferably small. The XRD intensity ratio Ic/Ia is, for example, 1.1 or less, may be 1.05 or less, and may be 1.00 or less. Meanwhile, when the peak “a” is not observed but the peak “c” is observed, Ia′ designates an intensity at 2θ=28.4°. An XRD intensity ratio Ic/Ia′ preferably satisfies the relationship same as that of the above described XRD intensity ratio Ic/Ia.

Also, in the anode active material in the present disclosure, a peak “d” derived from lithium silicate positioned at 2θ=20°−30° in an XRD measurement using a CuKα ray may not be observed or may be observed, but the former is preferable. The reason therefor is to allow the anode active material to have less impurities. The peak “d” is a peak derived from lithium silicate. Examples of the positions where the peak “d” is obtained at 2θ=20°−30° may include 2θ=24.7°±0.5° and 2θ=26.0°±0.5°. The peak “d” may be observed as a single peak, and may be observed as plural peaks. The lithium silicate is a compound containing Li, Si, and O, and Li₆Si₂O₇ typically falls under the compound. Also, the half value width of the peak “d” is usually smaller than the half value width of the peak “b”; for example, the peak “d” is 3° or less, may be 1° or less, and may be 0.5° or less.

When the peak “a” and the peak “d” are observed, Ia designates the intensity of the peak “a”, and Id designates the intensity of the peak “d”, an XRD intensity ratio Id/Ia is preferably small. The XRD intensity ratio Id/Ia is, for example, 0.8 or less, and may be 0.6 or less. Incidentally, when a plurality of the peak “d” is observed, Id designates the largest intensity among the plurality of the peak “d”. Meanwhile, when the peak “a” is not observed but the peak “d” is observed, Ia′ designates an intensity at 2θ=28.4°. An XRD intensity ratio Id/Ia′ preferably satisfies the same relation as that of the above described XRD intensity ratio Id/Ia.

Also, the anode active material in the present disclosure may include a specified void. The void is, for example, 5% or more, may be 10% or more, and may be 20% or more. Meanwhile, the void is, for example, 50% or less, may be 40% or less, and may be 30% or less. The void may be obtained in ways such as observation by a scanning electron microscope (SEM). The number of samples is preferably much; for example, it is 100 or more. The void may be an average value calculated from these samples.

Also, the anode active material in the present disclosure is used for a battery. The battery will be described in “C. Battery” later.

B. Method for Producing Anode Active Material

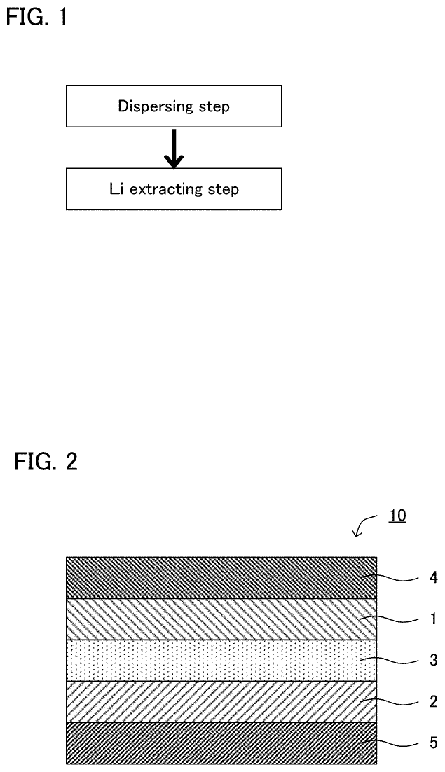

FIG. 1 is a flow chart illustrating an example of the method for producing the anode active material in the present disclosure. The method for producing the anode active material in the present disclosure comprises: a dispersing step of adding a dispersion medium to a LiSi precursor containing a Si element and a Li element to obtain a LiSi precursor dispersion solution; and a Li extracting step of extracting the Li element from the LiSi precursor by adding a Li extracting solvent to the LiSi precursor dispersion solution to obtain a particle in unwoven fabric shape that contains Si fiber. Also, in the present disclosure, a relative dielectric constant of the dispersion medium is 3.08 or less.

With the method for producing the anode active material in the present disclosure wherein the Li extracting step is conducted after the dispersing step, the anode active material that is a particle in unwoven fabric shape containing Si fiber can be produced. The reason therefor is considered to be because the dispersion medium used in the dispersing step has a specified relative dielectric constant and thus the reaction of the LiSi precursor with the Li extracting solvent is inhibited to restrain the speed of extracting Li elements from the LiSi precursor. It is considered that, the dispersion medium having a specified relative dielectric constant is used and thus, when the Li extracting solvent is added, the solvent is promptly mixed with the dispersing medium to decrease the Li extracting solvent concentration in the surface of the LiSi precursor. As a result, it is presumed that the reaction of the LiSi precursor with the Li extracting solvent is inhibited. Also, when the Li extracting reaction is inhibited in the above manner, it is presumed that just Li elements are extracted from the LiSi precursor and Si skeleton remains and thus the particle in unwoven fabric shape may be obtained. When the Li extracting reaction is not inhibited, it is presumed that the Si skeleton is extracted with Li elements at the same time and thus the particle in unwoven fabric shape may not be obtained.

1. Dispersing Step

The dispersing step in the present disclosure is a step of adding a dispersion medium to a LiSi precursor containing a Si element and a Li element to obtain a LiSi precursor dispersion solution.

There are no particular limitations on the LiSi precursor if it contains a Si element and a Li element; a commercially available product may be purchased, and the LiSi precursor may be produced by oneself. Examples of the method for preparing the LiSi precursor may include a method of mixing a raw material containing a Si element with a raw material containing a Li element. Examples of the mixing method may include a method of mixing Si particles with Li particles using an agate mortar under an Ar atmosphere, and a method of mixing Si particles with Li particles using mechanical milling.

The LiSi precursor preferably has a (diamond-shaped) Si crystal phase. The Si crystal phase has typical peaks at the positions of 2θ=28.4°, 47.3°, 56.1°, 69.2°, and 76.4° in an XRD measurement using a CuKα ray. These peak positions may be respectively shifted in a range of ±0.5°, and may be respectively shifted in a range of ±0.3°. The LiSi precursor may have the (diamond-shaped) Si crystal phase as a main phase. The “main phase” refers to a crystal phase to which a peak having the largest intensity in the XRD chart belong.

Also, there are no particular limitations on the composition of the LiSi precursor. The LiSi precursor may contain just a Li element and a Si element, and may further contain an additional metal element. The total proportion of the Li element and the Si element to all the metal elements included in the LiSi precursor is, for example, 50 mol % or more, may be 70 mol % or more, and may be 90 mol % or more. In the LiSi precursor, the proportion of the Li element to the total of the Si element and the Li element is, for example, 30 mol % or more, may be 50 mol % or more, and may be 80 mol % or more. Meanwhile, the proportion of the Li element is, for example, 95 mol % or less, and may be 90 mol % or less.

The relative dielectric constant of the dispersion medium in the present disclosure is 3.08 or less. The dispersion medium having relative dielectric constant of 3.08 or less is usually categorized into an aprotonic dispersion medium. The relative dielectric constant is 3.08 or less; for example, it may be 3.00 or less, and may be 2.50 or less. Meanwhile, the relative dielectric constant is, for example, 1.50 or more, may be 1.70 or more, may be 1.90 or more, and may be 2.00 or more. If the relative dielectric constant is much larger than 3.08, there is a risk that the dispersion medium itself would react with the LiSi precursor and be condensed, and the LiSi precursor may not be dispersed well. Incidentally, the relative dielectric constant may be measured by, for example, a method described in JIS C 2565 (such as a method using a cavity resonator).

The dispersion medium may not or may include a benzene ring, but the latter is preferable. Also, examples of the dispersion medium may include a saturated hydrocarbon such as n-heptane, n-octane, n-decan, 2-ethyl hexane, and cyclohexane; an unsaturated hydrocarbon such as hexene and heptene; an aromatic hydrocarbon such as 1,3,5-trimethyl benzene, toluene, xylene, ethyl benzene, propyl benzene, cumene, 1,2,4-trimethyl benzene, and 1,2,3-trimethyl benzene; and ethers such as n-butyl ether, n-hexyl ether, isoamyl ether, diphenyl ether, methyl phenyl ether, and cyclopentyl methyl ether. Among these, n-butyl ether, 1,3,5-trimethyl benzene and n-heptane are preferable, and 1,3,5-trimethyl benzene is particularly preferable. Incidentally, the relative dielectric constant of n-butyl ether is 3.08, the relative dielectric constant of 1,3,5-trimethyl benzene is 2.279, and the relative dielectric constant of n-heptane is 1.94.

Also, it is preferable that the amount of moisture in the dispersion medium is small. The reason therefor is that the moisture reacts with the LiSi precursor. The amount of moisture in the dispersion medium is, for example, 100 ppm or less, may be 50 ppm or less, may be 30 ppm or less, and may be 10 ppm or less.

The LiSi precursor dispersion solution may be obtained by adding a dispersion medium to the LiSi precursor and mixing thereof. There are no particular limitations on the mixing method.

The average particle size D₅₀ of the anode active material in the present disclosure may be adjusted by, for example, changing the kind of the dispersion medium. The average particle size D₅₀ may also be adjusted by the combination of the kind of the dispersion medium and a later described Li extracting solvent. The average particle size D₅₀ may also be adjusted by changing the average particle size of the LiSi precursor itself.

The main factor of the XRD intensity ratio of the anode active material of the present disclosure is the speed of extracting Li from the LiSi precursor (reactivity of the LiSi uprecursor with the Li extracting solvent). If the speed of extracting Li is slow, the XRD intensity ratio would be low and a low crystalline silicon would be obtained. Thereby, the XRD intensity ratio may be adjusted by, for example, the kind of the dispersion medium, the kind of the Li extracting solvent described later, and the combination of the dispersion medium and the Li extracting solvent.

2. Li Extracting Step

The Li extracting step in the present disclosure is a step of extracting a Li element from the LiSi precursor by adding a Li extracting solvent to the LiSi precursor dispersion solution to obtain the above described particle in unwoven fabric shape.

There are no particular limitations on the Li extracting solvent if it is a solvent that allows a Li element to be extracted from the LiSi precursor. Examples of the Li extracting solvent may include a primary alcohol such as methanol, ethanol, 1-propanol, 1-butanol, 1-pentanol, and 1-hexanol; a secondary alcohol such as 2-propanol, 2-butanol, 2-pentanol, and 2-hexanol; a tertiary alcohol such as tert-butyl alcohol; phenols such as phenol; a glycol such as 1,2-ethane diol and 1,3-butan diol; a glycol ether such as propylene glycol monomethyl ether and ethylene glycol monomethyl ether; pyranoses such as b-D-glucopyranose; furanoses such as erythrofuranose; and polysaccharides such as glucoses and fructoses. Examples of the Li extracting solvent may also include a solution of acid such as acetic acid, formic acid, propionic acid, and oxalic acid. Among those, the Li extracting solvent is preferably at least one kind of ethanol, 1-propanol, 1-butanol, 1-hexanol, and acetic acid. As the Li extracting solvent, just one kind of the above compound may be used, and two kinds or more thereof may be used. Also, the amount of moisture in the Li extracting solvent is preferably little. The amount of moisture in the Li extracting solvent is, for example, 100 ppm or less, may be 50 ppm or less, may be 30 ppm or less, and may be 10 ppm or less. If the amount of moisture is too much, there is a risk that Si is oxidized to deteriorate battery performance.

The Li extracting step may be configured by one stage, or two stages. For example, when the Li extracting step is configured by one stage, it may be a step of bring cooled LiSi precursor dispersion solution into react with an arbitrary Li extracting solvent except for the aforementioned acid solution. When the Li extracting step is configured by two stages, it may be a step configured by the above described first stage and a second stage of bringing the reaction solution in the first stage into react with the aforementioned acid solution. When the Li extracting step is configured by two stages, an Li element may be more certainly extracted from the LiSi precursor.

3. Washing Step

Also, in the present disclosure, a washing step may be conducted after the Li extracting step.

In the present disclosure, with the conduction of the washing step, impurities may be prevented from mixing in the anode active material. Also, with the anode active material including not much impurities, condensation is inhibited, and thus an anode active material of which expansion along with charge is further smaller may be produced. Also, the expansion and the increase in restraining pressure of a battery using such an anode active material may be further inhibited. The impurities are considered to be, for example, a biproduct in which Li and Si included in the solution after extracting Li are polymerized as follows.

There is a possibility that a reaction solution in which Li and Si are dissolved in the state of ethoxy lithium and tetraethoxy silane may be adhered to the surface of the particle in unwoven fabric shape after the Li extracting step. Ethoxy lithium and tetraethoxy silane have characteristics of forming glass by hydrolysis and dehydration synthesis (sol-gel reaction) when reacting with moisture in the atmosphere. For that reason, there is a possibility that materials such as lithium silicate such as Li₆Si₂O₇ and SiO₂ may remain as impurities in the surface of the anode active material. The sol-gel reaction here is accelerated by a base catalyst. Accordingly, with the conduction of the washing step in the present disclosure, the reaction solution may be removed from the surface of the particle in unwoven fabric shape while inhibiting the sol-gel reaction. As a result, the impurities are inhibited from remaining in the surface of the anode active material, and the condensation of the anode active material may be inhibited.

When the concentration of the LiSi precursor is high in the total of the LiSi precursor solution and the Li extracting solvent, although the production efficiency improves, formation of the impurities increases. Then, when the concentration of the LiSi precursor is 3.3 g/L or more, conduction of the washing step allows both the improvement of the production efficiency and the reduction of formation of the impurities.

The washing step in the present disclosure is a step of washing the particle in unwoven fabric shape by an acid after the Li extracting step. The washing step usually includes a collecting process of collecting the particle in unwoven fabric shape from the solution after the Li extracting step, and a washing process of washing the collected particle in unwoven fabric shape by an acid. There are no particular limitations on the collecting process if it is a method with which the particle in unwoven fabric shape may be collected, and examples of the method may include filtration to the reaction solution after the Li extracting step.

The washing process is a process of washing the particle in unwoven fabric shape by an acid, and is not particularly limited if it is a method in which the particle in unwoven fabric shape is made contact the acid. Examples of such a method may include a method of continuous filtration by pouring a solution including the acid to the particle in unwoven fabric shape collected in the aforementioned filtration. There are no particular limitations on the time and the number of the washing process.

There are no particular limitations on the acid used in the washing step, and the same acids exemplified as the Li extracting solvent may be used. Incidentally, the acid used in the washing process is preferably the same kind of acid used in the Li extracting step.

The anode active material obtained by the above described steps may be collected with an arbitrary method. Examples of the method may include a method of separating a solid reactant (anode active material) respectively from the solution after the Li extracting step and the solution after the washing step, and then drying the obtained anode active material.

4. Anode Active Material

The anode active material obtained by the above described production method is in the same contents as those described in “A. Anode active material” above; thus, the descriptions herein are omitted.

C. Battery

FIG. 2 is a schematic cross-sectional view illustrating an example of the battery in the present disclosure. Battery 10 illustrated in FIG. 2 comprises cathode active material layer 1, anode active material layer 2, electrolyte layer 3 formed between the cathode active material layer 1 and the anode active material layer 2, cathode current collector 4 for collecting currents of the cathode active material layer 1, and anode current collector 5 for collecting currents of the anode active material layer 2. These members may be stored in a general outer package. In the present disclosure, the anode active material layer 2 contains the above described anode active material.

According to the present disclosure, the anode active material layer contains the above described anode active material, and thus the battery of which restraining pressure is reduced may be obtained.

1. Anode Active Material Layer

The anode active material layer is a layer containing at least the above described anode active material. The anode active material is in the same contents as those described in “A. Anode active material” above; thus, the descriptions herein are omitted.

As the anode active material, the anode active material layer may contain just the above described anode active material, and may further contain an additional anode active material. In the latter case, the proportion of the above described anode active material in all the anode active materials may be, for example, 50 weight % or more, may be 70 weight % or more, and may be 90 weight % or more.

The proportion of the anode active material in the anode active material layer is, for example, 20 weight % or more, may be 30 weight % or more, and may be 40 weight % or more. Meanwhile, the proportion of the anode active material is, for example, 80 weight % or less, may be 70 weight % or less, and may be 60 weight % or less.

Also, the anode active material layer may further contain at least one of an electrolyte, a conduction aiding agent, and a binder, as required. The kind of the electrolyte will be described in details in “3. Electrolyte layer” later. The proportion of the electrolyte in the anode active material layer is, for example, 1 weight % or more, may be 10 weight % or more, and may be 20 weight % or more. Meanwhile, the proportion of the electrolyte in the anode layer is, for example, 60 weight % or less, and may be 50 weight % or less.

Examples of the conduction aiding agent may include a carbon material and a metal particle. Specific examples of the carbon material may include a particle shaped carbon material such as acetylene black (AB) and Ketjen black (KB), and a fiber shaped carbon material such as carbon fiber, carbon nanotube (CNT), and carbon nanofiber (CNF). Examples of the metal particle may include Ni, Cu, Fe, and SuS. The proportion of the conduction aiding agent in the anode active material layer is, for example, 1 weight % or more, and may be 5 weight % or more. Meanwhile, the proportion of the conduction aiding agent is, for example, 30 weight % or less, and may be 20 weight % or less.

Examples of the binder may include a rubber-based binder such as a butadiene rubber, a hydrogenated butadiene rubber, a styrene butadiene rubber (SBR), a hydrogenated styrene butadiene rubber, a nitrile butadiene rubber, a hydrogenated nitrile butadiene rubber, and an ethylene propylene rubber; a fluoride-based binder such as polyvinylidene fluoride (PVDF), a polyvinylidene fluoride-polyhexafluoro propylene copolymer (PVDF-HFP), polytetrafluoro ethylene, and a fluorine rubber; a polyolefin-based thermoplastic resin such as polyethylene, polypropylene, and polystyrene; an imide-based resin such as polyimide and polyamide imide; an amide-based resin such as polyamide; an acrylic resin such as polymethyl acrylate and polyethyl acrylate; and a methacrylic resin such as polymethyl methacrylate and polyethyl methacrylate. The proportion of the binder in the anode active material layer is, for example, 1 weight % or more and 30 weight % or less.

The thickness of the anode active material layer is, for example, 0.1 μm or more and 1000 μm or less.

2. Cathode Active Material Layer

The cathode active material layer is a layer containing at least a cathode active material. Also, the cathode active material layer may further contain at least one of an electrolyte, a conduction aiding agent, and a binder, as required.

Examples of the cathode active material may include an oxide active material. Examples of the oxide active material that may be used in a lithium ion battery may include oxide active materials such as LiCoO₂, LiMnO₂, Li₂NiMn₃O₈, LiVO₂, LiCrO₂, LiFePO₄, LiCoPO₄, LiNiO₂, and LiNi_{1/3}Co_{1/3}Mn_{1/3}O₂. Also, a coating layer containing a Li ion conductive oxide such as LiNbO₃ may be formed on the surface of these active materials.

The proportion of the cathode active material in the cathode active material layer is, for example, 20 weight % or more, may be 30 weight % or more, and may be 40 weight % or more. Meanwhile, the proportion of the cathode active material is, for example, 80 weight % or less, may be 70 weight % or less, and may be 60 weight % or less.

Incidentally, the kind and the proportion of the solid electrolyte, the conduction aiding agent, and the binder to be used for the cathode active material layer may be in the same contents as those described for the anode active material layer described above; thus, the descriptions herein are omitted.

The thickness of the cathode active material layer is, for example, 0.1 μm or more and 1000 μm or less.

3. Electrolyte Layer

The electrolyte layer is a layer formed between the cathode active material layer and the anode active material layer. An electrolyte configuring the electrolyte layer may be an electrolyte solution (liquid electrolyte), and may be a solid electrolyte, but the latter is preferable.

Typical examples of the solid electrolyte may include an inorganic solid electrolyte such as a sulfide solid electrolyte, a nitride solid electrolyte, and a halide solid electrolyte; and an organic polymer electrolyte such as a polymer electrolyte.

Examples of the sulfide solid electrolyte having lithium ion conductivity may include a solid electrolyte containing a Li element, an X element (X is at least one kind of P, As, Sb, Si, Ge, Sn, B, Al, Ga, and In), and a S element. Also, the sulfide solid electrolyte may further contain at least either one of an O element and a halogen element. Examples of the halogen element may include a F element, a Cl element, a Br element, and an I element.

Examples of the sulfide solid electrolyte may include Li₂S—P₂S₅, Li₂S—P₂S₅—LiI, Li₂S—P₂S₅-GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LII, Li₂S—SiS₂-LiBr, Li₂S—SiS₂—LiCl, Li₂S—SiS₂—B₂S₃—LiI, Li₂S—SiS₂—P₂S₅—LiI, Li₂S—B₂S₃, Li₂—P₂S₅—ZₘSₙ (provided that m and n are respectively a real number; Z is one of Ge, Zn, and Ga), Li₂S—GeS₂, Li₂S—SiS₂—Li₃PO₄, and Li₂S—SiS₂—LiₓMO_{y} (provided that x and y are respectively a real number; M is one of P, Si, Ge, B, Al, Ga, and In).

Also, examples of the oxide solid electrolyte having lithium ion conductivity may include a solid electrolyte containing a Li element, a Y element (Y is at least one kind of Nb, B, Al, Si, P, Ti, Zr, Mo, W, and S), and an O element. Specific examples thereof may include a garnet type solid electrolyte such as Li₇La₃Zr₂O₁₂, Li₇₋ₓLa₃(Zr₂₋ₓNbₓ)O₁₂ (0≤x≤2), Li₅La₃Nb₂O₁₂; a perovskite type solid electrolyte such as (Li,La)TiO₃, (Li,La)NbO₃, and (Li,Sr) (Ta,Zr)O₃; a nasicon type solid electrolyte such as Li(Al,Ti) (PO₄)₃ and Li(Al,Ga) (PO₄)₃; a Li-P-O-based solid electrolyte such as Li₃PO₄ and LIPON (a compound in which a part of O in Li₃PO₄ is substituted with N); and a Li-B-O-based solid electrolyte such as Li₃BO₃ and a compound in which a part of O in Li₃BO₃ is substituted with C.

The binder is in the same contents as those described in “1. Anode active material layer” above; thus, the descriptions herein are omitted.

The thickness of the electrolyte layer is, for example, 0.1 μm or more and 1000 ∞m or less.

4. Other Constitutions

The battery in the present disclosure comprises at least the above described anode active material layer, cathode active material layer, and electrolyte layer, and usually further comprises a cathode current collector for collecting currents of the cathode active material layer and an anode current collector for collecting currents of the anode active material layer. Examples of the material for the cathode current collector may include SUS, aluminum, nickel, iron, titanium, and carbon. Meanwhile, examples of the material for the anode current collector may include SUS, copper, nickel, and carbon.

5. Battery

The battery in the present disclosure is preferably a lithium ion battery. Also, the battery in the present disclosure may be a liquid-based battery and may be an all solid state battery, but the latter is preferable.

Also, the battery in the present disclosure may be a primary battery and may be a secondary battery, but preferably a secondary battery among them since it can be repeatedly charged and discharged and useful as a car-mounted battery for example. The secondary battery includes a use of the secondary battery as a primary battery (use for the purpose of just the first charge).

Also, the battery in the present disclosure may be a single cell, and may be a stacked cell. The stacked cell may be a monopolar type stacked cell (stacked cell connected in parallel) and may be a bipolar type stacked cell (stacked cell connected in series). Examples of the shape of the battery may include a coin shape, a laminate shape, a cylindrical shape, and a square shape.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Synthesis of Anode Active Material>

Si particles (particle size: 5 μm, from Kojundo Chemical Laboratory Co., Ltd.) of 0.65 g and a Li metal (from Honjo Metal Co., Ltd.) of 0.60 g were mixed by an agate mortar under an Ar atmosphere, and thereby a LiSi precursor was obtained. Inside a glass reactor under an argon atmosphere, the LiSi precursor of 1.0 g, and a dispersion medium (1,3,5-trimethyl benzene, from NACALAI TESQUE, INC.) of 125 ml were mixed using an ultrasonic homogenizer (UH-50 from SMT Co., LTD.). After mixing, obtained LiSi precursor dispersion solution was cooled to 0° C., ethanol (from NACALAI TESQUE, INC.) of 125 ml was dropped thereto and reaction was conducted for 120 minutes. After the reaction, acetic acid (from NACALAI TESQUE, INC.) of 50 ml was further dropped thereto and reaction was conducted for 60 minutes. After the reaction, a liquid and a solid reactant (anode active material) were separated by suction filtration. An obtained solid reactant was vacuum dried at 120° C. for 2 hours, and thereby the anode active material was collected. The average particle size D.50 of the obtained anode active material measured was 0.27 μm.

<Synthesis of Solid Electrolyte>

Li₂S (from Furuuchi Chemical Corporation) of 0.550 g, P₂S₅ (from Sigma-Aldrich) of 0.887 g, LiI (from NIPPOH CHEMICALS CO., LTD.) of 0.285 g, and LiBr (from Kojundo Chemical Laboratory Co., Ltd.) of 0.277 g were mixed with an agate mortar for 5 minutes. To an obtained mixture, n-heptane (dehydration grade, from KANTO CHEMICAL CO., INC.) of 4 g was added and mechanical milling was conducted thereto for 40 hours using a planetary ball mill, and thereby a solid electrolyte was obtained.

<Production of Evaluation Battery>

LiNi_{1/3}Co_{1/3}Mn_{1/3}O₂ (from NICHIA CORPORATION) was subjected to a surface treatment using LiNbO₃, and thereby a cathode active material was obtained. This cathode active material of 1.5 g, a conduction aiding agent (VGCF, from Showa Denko K.K.) of 0.023 g, the solid electrolyte of 0.239 g, and a binder (PVdF, from KUREHA CORPORATION) of 0.011 g, and a butyl butylate (from Kishida Chemical Co., Ltd.) of 0.8 g were mixed using an ultrasonic homogenizer (UH-50, from SMT Co., Ltd.), and thereby a cathode mixture was obtained.

The synthesized anode active material of 1.0 g, a conduction aiding agent (VGCF, from Showa Denko K.K.) of 0.04 g, the solid electrolyte of 0.776 g, a binder (PVdF, from KUREHA CORPORATION) of 0.02 g, and a butyl butylate (from Kishida Chemical Co., Ltd.) of 1.7 g were mixed using an ultrasonic homogenizer (UH-50, from SMT Co., Ltd.), and thereby an anode mixture was obtained.

The solid electrolyte of 0.065 g was put into a 1 cm² mold made of ceramic, pressed at 1 ton/cm², and thereby a separating layer (solid electrolyte layer) was produced. The cathode mixture of 0.018 g was placed on one side of the separating layer, pressed at 1 ton/cm², and thereby a cathode active material layer was produced. The anode mixture of 0.0054 g was placed on the other side to the cathode active material layer, pressed at 4 ton/cm², and thereby an anode active material layer was produced. Also, an aluminum foil as a cathode current collector, and a copper foil as an anode current collector were used. In this manner, an evaluation battery (all solid state battery) was produced.

### Examples 2 to 7

An anode active material was synthesized and an evaluation battery was produced in the same manner as in Example 1, except that the dispersion medium and the Li extracting solvent were changed as in Table 1. Also, the average particle size D₅₀ of each of the obtained anode active material was measured. The results are shown in Table 2.

### Comparative Example 1

An anode active material was synthesized and an evaluation battery was produced in the same manner as in Example 1, except that the dispersion medium was not used and ethanol cooled to 0° C. was used as the Li extracting solvent in the synthesis of the anode active material. Also, the average particle size D.50 of the obtained anode active material was measured. The results are shown in Table 2.

### Comparative Examples 2 to 4

An anode active material was synthesized and an evaluation battery was produced in the same manner as in Comparative Example 1, except that the Li extracting solvent was changed as in Table 1. Also, the average particle size D₅₀ of the obtained anode active material was measured. The results are shown in Table 2.

[Evaluation 1]

<XRD Measurement>

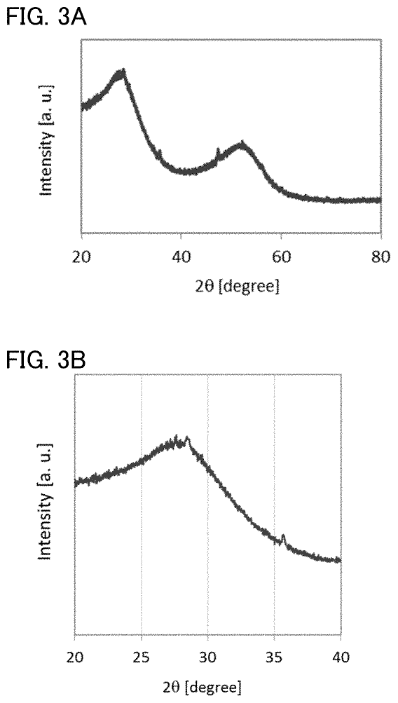

An X-ray diffraction (XRD) measurement using a CuKα ray was conducted to the anode active materials obtained in Examples 1 to 7 and Comparative Examples 1 to 4. XRD data obtained for Example 1 is shown in FIG. 3A and FIG. 3B. FIG. 3B is an enlarged graph of a part of FIG. 3A. As shown in FIG. 3A, halo peaks were confirmed in the vicinity of 2θ=25° to 30° and 2θ=50° to 60°. Incidentally, the former peak corresponds to peak “b”. Also, as shown in FIG. 3B, peak “a” was extremely slightly confirmed at the position of 2θ=28.4°. Incidentally, FIG. 3B is in a level that can be judged as “peak “a” was not confirmed”. Also, in FIGS. 3A and 3B, the peak position of peak “a” almost matched the peak position of peak “b”. From this data, XRD intensity ratio Ia/Ib was obtained: Ia/Ib=0.99; thus, Ia and Ib were almost the same intensity. XRD intensity ratios for Examples 2 to 7 and Comparative Examples 1 to 4 were obtained in the same manner. The results are shown in Table 2.

As shown in Table 2, XRD intensity ratios of Examples 1 to 7 were smaller than those of Comparative Examples 1 to 4, and it was confirmed that the crystallinity of the anode active material was lower and more amorphous.

<Microscope Observation>

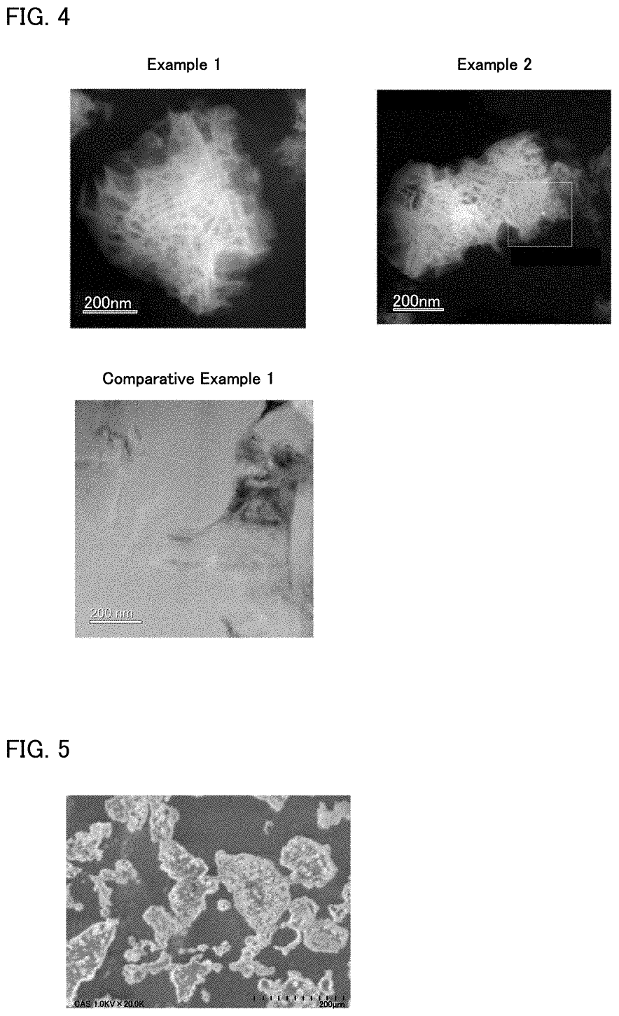

The shapes of the anode active materials obtained in Examples 1 to 2 and Comparative Example 1 were observed using a transmission electron microscope (TEM). The results are shown in FIG. 4. Also, the shape of the anode active material obtained in Comparative Example 1 was observed using a scanning electron microscope (SEM). The result is shown in FIG. 5.

As shown in FIG. 4, it was confirmed that Si fibers were three-dimensionally entangled in the anode active material of Examples where the LiSi precursor was dispersed to the dispersion medium and then Li was extracted. On the other hand, the shape of the anode active material in Comparative Example 1 where the LiSi precursor was not dispersed to the dispersion medium and Li was extracted, was completely different from that of Examples. As it can be seen from the SEM image shown in FIG. 5, this is because the shape of the anode active material in Comparative Example 1 was not in unwoven fabric shape, but in a shape where particles formed just porous. The reason why the fiber shape was not confirmed for Comparative Example 1 was presumably because the Li extracting reaction was not inhibited and thus not only Li elements but also the Si skeleton was extracted at the same time from the LiSi precursor.

<Void, Average Diameter, and Aspect Ratio>

The cross-sectional images of the anode active materials obtained in Examples 1 to 7 and Comparative Examples 1 to 4 were obtained using a scanning electron microscope (SEM) and void thereof was measured. Also, for Examples, the average diameter and the aspect ratio of the Si fiber were also calculated. The results are shown in Table 2.

As shown in Table 2, the voids of Examples 1 to 4 were higher than those of Comparative Examples 1 to 4, but the void of Examples 5 to 7 were lower than that of Comparative Example 1 (void: 12%). In general, expansion (restraining pressure increase amount) tends to be small when the void is high since the void can absorb the expansion. However, as described later, the restraining pressure increase amounts of Examples 5 to 7 of which voids were smaller than Comparative Example 1, were remarkably small. Also, it was confirmed that the aspect ratio of Examples was respectively 1 or more, and thus it was in fiber shape.

<Restraining Pressure Increase Amount>

Evaluation batteries obtained in Examples 1 to 7 and Comparative Examples 1 to 4 were CC/CV charged at 0.245 mA to 4.55 V, and then CC/CV discharged at 0.245 mA to 3.0 V. In the first charge, the restraining pressure of each battery was monitored and the restraining pressure at 4.55 V was measured. Relative evaluation was conducted using the restraining pressure of Comparative Example 1 as 1.00. The results are shown in Table 2. As shown in Table 2, the restraining pressure increase amounts of Examples 1 to 7 were remarkably smaller than those of Comparative Examples 1 to 4.

TABLE 1

| | |
|---|---|
| Dispersion medium | |
| (Relative dielectric | |
| constant) | Li extracting solvent |

| | | | |
|---|---|---|---|
| Example 1 | 1,3,5-trimethyl | Ethanol | Acetic |
| | benzene | | acid |
| | (2.279) | | |
| Example 2 | n-butyl ether | Ethanol | Acetic |
| | (3.08) | | acid |
| Example 3 | n-heptane | Ethanol | Acetic |
| | (1.94) | | acid |
| Example 4 | 1,3,5-trimethyl | 1-propanol | Acetic |
| | benzene | | acid |
| | (2.279) | | |
| Example 5 | n-butyl ether | 1-propanol | Acetic |
| | (3.08) | | acid |
| Example 6 | 1,3,5-trimethyl | 1-butanol | Acetic |
| | benzene | | acid |
| | (2.279) | | |
| Example 7 | 1,3,5-trimethyl | 1-hexanol | Acetic |
| | benzene | | acid |
| | (2.279) | | |
| Comparative | — | Ethanol | Acetic |
| Example 1 | | | acid |
| Comparative | — | 1-propanol | Acetic |
| Example 2 | | | acid |
| Comparative | — | 1-butanol | Acetic |
| Example 3 | | | acid |
| Comparative | — | 1-hexanol | Acetic |
| Example 4 | | | acid |

TABLE 2

| | Average | XRD | | | | Restraining |
|---|---|---|---|---|---|---|
| | particle | intensity | Average | | | pressure |
| | size | ratio | diameter | Aspect | Void | increase |
| | [D₅₀ μm] | (Ia/Ib) | (nm) | ratio | [%] | amount |
| Example 1 | 0.27 | 0.99 | 14 | 30 | 14 | 0.51 |
| Example 2 | 0.42 | 1.06 | 28 | 20 | 15 | 0.52 |
| Example 3 | 1.40 | 1.20 | 26 | 20 | 14 | 0.60 |
| Example 4 | 0.92 | 1.70 | 29 | 20 | 13 | 0.57 |
| Example 5 | 2.03 | 1.65 | 34 | 10 | 11 | 0.62 |
| Example 6 | 2.60 | 2.15 | 46 | 25 | 11 | 0.68 |
| Example 7 | 3.58 | 3.80 | 68 | 5 | 10 | 0.69 |
| Comparative | 15.96 | 5.80 | — | — | 12 | 1.00 |
| Example 1 | | | | | | |
| Comparative | 16.31 | 6.83 | — | — | 10 | 1.09 |
| Example 2 | | | | | | |
| Comparative | 16.52 | 13.67 | — | — | 9 | 1.07 |
| Example 3 | | | | | | |
| Comparative | 19.23 | 20.50 | — | — | 8 | 1.05 |
| Example 4 | | | | | | |

As described above, with the method for producing the anode active material in the present disclosure, it was confirmed that the anode active material in unwoven fabric shape having small average particle size and low crystallinity was obtained. It was also confirmed that the restraining pressure increase amount of a battery was remarkably inhibited when the above described anode active material obtained was used for an all solid state battery.

### Example 8

An anode active material was synthesized and an evaluation battery was produced in the same manner as in Example 1.

### Example 9

As shown in Table 3, in the synthesis of anode active material, the LiSi precursor of 12 g, 1,3,5-trimethyl benzene of 400 ml, ethanol of 400 mL, and acetic acid of 600 mL were used. An anode active material was synthesized and an evaluation battery was produced in the same manner as in Example 1 except the above. Also, the average particle size D₅₀ of the obtained anode active material was measured and the result was 1.34 μm.

### Example 10

As shown in Table 3, in the synthesis of anode active material, the LiSi precursor of 12 g, 1,3,5-trimethyl benzene of 400 ml, ethanol of 400 mL, and acetic acid of 600 mL was used. Also, after the reaction of the LiSi precursor dispersion solution with acetic acid, liquid and a solid reactant were separated by suction filtration using a filter. Then, acetic acid of 100 mL was poring to the solid reactant deposited on the filter for continuous suction filtration, and thereby the solid reactant was washed by acetic acid. The solid reactant washed was vacuum-dried at 120° C. for 2 hours, and thereby an anode active material was synthesized. An evaluation battery was produced in the same manner as in Example 1 except the above. Also, the average particle size D₅₀ of the obtained anode active material was measured and the result was 0.61 μm.

[Evaluation 2]

<XRD Measurement>

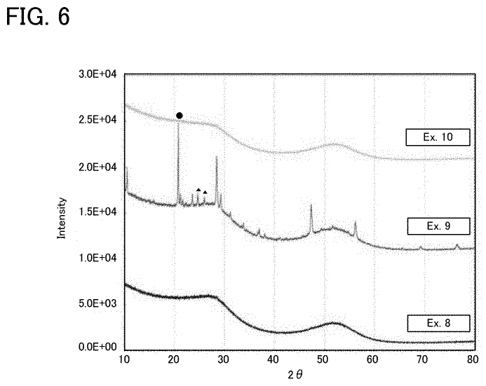

An X-ray diffraction (XRD) measurement using a CuKα ray was conducted to the anode active materials obtained in Examples 8 to 10 in the same manner as in Evaluation 1. XRD data obtained is shown in FIG. 6. As shown in FIG. 6, peak “c” derived from SiO₂ and peak “d” derived from lithium silicate were confirmed in Example 9. Meanwhile, peak “c” derived from SiO₂ and peak “d” derived from lithium silicate were not confirmed in Examples 8 and 10. Incidentally, in FIG. 6, ● indicates peak “c” and ▴ indicates peak “d”.

<Restraining Pressure Increase Amount>

The restraining pressures of the evaluation batteries obtained in Examples 8 to 10 were measured in the same manner as in Evaluation 1. Relative evaluation was conducted using the restraining pressure of Example 8 as 1.00. The results are shown in Table 4.

TABLE 3

| | Materials for Li extracting step | | | | |
|---|---|---|---|---|---|
| | | 1,3,5-trimethyl | | Acetic | |
| | LiSi | benzene | Ethanol | acid | Washing |
| | (g) | (mL) | (mL) | (mL) | step |
| Example 8 | 1 | 125 | 125 | 50 | Not |
| | | | | | conducted |
| Example 9 | 12 | 400 | 400 | 600 | Not |
| | | | | | conducted |
| Example 10 | 12 | 400 | 400 | 600 | Conducted |

TABLE 4

| | Average | Restraining |
|---|---|---|
| | particle size | pressure |
| | [D₅₀ μm] | increase amount |
| Example 8 | 0.27 | 1.00 |
| Example 9 | 1.34 | 1.23 |
| Example 10 | 0.61 | 0.95 |

As shown in Table 4, in Example 9 where the producing size of the anode active material was increased and the washing step was not conducted, the average particle size and the restraining pressure increase amount of the anode active material were larger than those of Example 8. On the other hand, in Example 10 where the washing step was conducted, the average particle size of the anode active material was smaller than that of Example 8 and Example 9, and the restraining pressure increase amount was inhibited further. This is presumably because impurities such as SiO₂ and lithium silicate were removed in the washing step. In this manner, it was confirmed that the condensation of the anode active material due to remaining impurities was inhibited, and the restraining pressure increase amount was also inhibited further when the washing step was conducted in the method for producing the anode active material in the present disclosure.

### REFERENCE SINGS LIST

1 cathode active material layer
2 anode active material layer
3 electrolyte layer
4 cathode current collector
5 anode current collector
10 battery

What is claimed is:

1. An anode active material to be used for a battery, wherein
the anode active material is a particle in unwoven shape that contains Si fiber,
an average particle size D₅₀ of the anode active material is 0.2 μm or more and 3.6 μm or less, and
the anode active material is amorphous.

2. The anode active material according to claim 1, wherein a peak “a” derived from Si positioned at 2θ=28.4°±0.5° in an XRD measurement using a CuKα ray is not observed.

3. The anode active material according to claim 1, wherein a peak “a” derived from Si positioned at 2θ=28.4°±0.5° in an XRD measurement using a CuKα ray is observed,
a peak “b” positioned at 2θ=24.0°−32.0° of which half value width is 3° or more is observed, and
when Ia designates an intensity of the peak “a”, and Ib designates an intensity of the peak “b”, an XRD intensity ratio Ia/Ib is 3.80 or less.

4. The anode active material according to claim 1, wherein a peak “c” derived from SiO₂ positioned at 2θ=20.8°±0.5° in an XRD measurement using a CuKα ray is not observed.

5. The anode active material according to claim 1, wherein a peak “d” derived from lithium silicate positioned at 2θ=20°−30° in an XRD measurement using a CuKα ray is not observed.

6. The anode active material according to claim 1, wherein an average diameter of the Si fiber is 8 nm or more and 70 nm or less.

7. The anode active material according to claim 1, wherein an aspect ratio which is a ratio of average length/average diameter is 1 or more and 50 or less.

8. A method for producing an anode active material, the method comprising:
a dispersing step of adding a dispersion medium to a LiSi precursor containing a Si element and a Li element to obtain a LiSi precursor dispersion solution; and
a Li extracting step of extracting the Li element from the LiSi precursor by adding a Li extracting solvent to the LiSi precursor dispersion solution to obtain a particle in unwoven fabric shape that contains Si fiber, wherein
a relative dielectric constant of the dispersion medium is 3.08 or less.

9. The method for producing an anode active material according to claim 8, wherein the dispersion medium is at least one kind of n-butyl ether, 1,3,5-trimethyl benzene, and n-heptane.

10. The method for producing an anode active material according to claim 8, wherein the Li extracting solvent is at least one kind of ethanol, 1-propanol, 1-butanol, 1-hexanol, and acetic acid.

11. The method for producing an anode active material according to claim 8, further comprising a washing step of washing the particle in unwoven fabric shape by an acid after the Li extracting step.

12. A battery including a cathode active material layer, an anode active material layer, an electrolyte layer formed between the cathode active material layer and the anode active material layer, wherein
the anode active material layer contains the anode active material according to claim 1.
